(19) United States
(12) Patent Application Publication
(10) Pub. No.: US 2022/0288798 A1
(43) Pub. Date: Sep. 15, 2022

(54) Folding Knife With Tape Cutter

(71) Applicant: Strike Industries, Inc., Santa Ana, CA (US)

(72) Inventors: Shanyao Lee, Santa Ana, CA (US); Hung-Ju Lee, Santa Ana, CA (US)

(21) Appl. No.: 17/200,312

(22) Filed: Mar. 12, 2021

(51) Int. Cl. B26B 1/10; B26B 1/02

(52) U.S. Cl. CPC B26B 1/10; B26B 1/02

(57) ABSTRACT

A handheld tool includes a handle portion and a knife portion. The handle portion has a first distal end and a second distal end opposite the first distal end. The knife portion is coupled to the first distal end of the handle portion, and the knife portion has a sharp blade. The second distal end of the handle portion is configured with a dull blade.

### TECHNICAL FIELD

The present disclosure is generally related to hand tools and, more particularly, to a folding knife with a tape cutter.

### BACKGROUND

Unless otherwise indicated herein, approaches described in this section are not prior art to the claims listed below and are not admitted as prior art by inclusion in this section.

Generally speaking, some people usually use a knife as a box opener when opening and/or unpackaging a box, especially when the box is taped with packaging tapes. That is, a user would use the knife to cut out or cut open the tapes to open the box. However, doing so could be dangerous as it is possible for the knife to slice or cut the user's finger(s) or object(s) inside the box during the unpackaging process if cutting too deep, for example. Besides, after use, the blade of the knife could end up with residue of adhesives from the packaging tapes and thus become dirty. There is, therefore, a need for a solution to address such issues.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose designs of a handheld tool functioning as a folding knife with a tape cutter. With a designated tape cutter in addition to the folding knife, it is believed that such a handheld tool could be a solution to address aforementioned issues.

In one aspect, a device may include a handheld tool including a handle portion and a knife portion. The handle portion may have a first distal end and a second distal end opposite the first distal end. The knife portion may be coupled to the first distal end of the handle portion, and the knife portion may include a sharp blade. The second distal end of the handle portion may be configured with a dull blade.

In another aspect, a device may include a handheld tool including a handle portion and a knife portion. The handle portion may have a first distal end and a second distal end opposite the first distal end. The handle portion may include a first panel, a second panel, and a central panel sandwiched between the first panel and the second panel. The knife portion may be pivotably coupled to the first distal end of the handle portion, and the knife portion may include a sharp blade. The second distal end of the handle portion may be configured with a dull blade. A material of the dull blade may include metal, polymer, or both.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, explain the principles of the disclosure. It is appreciable that the drawings are not necessarily in scale as some components may be shown to be out of proportion than the size in actual implementation to clearly illustrate the concept of the present disclosure.

FIG. 1 is a diagram of a respective view of a device in accordance with an implementation of the present disclosure.

FIG. 2 is a diagram of a respective view of a device in accordance with an implementation of the present disclosure.

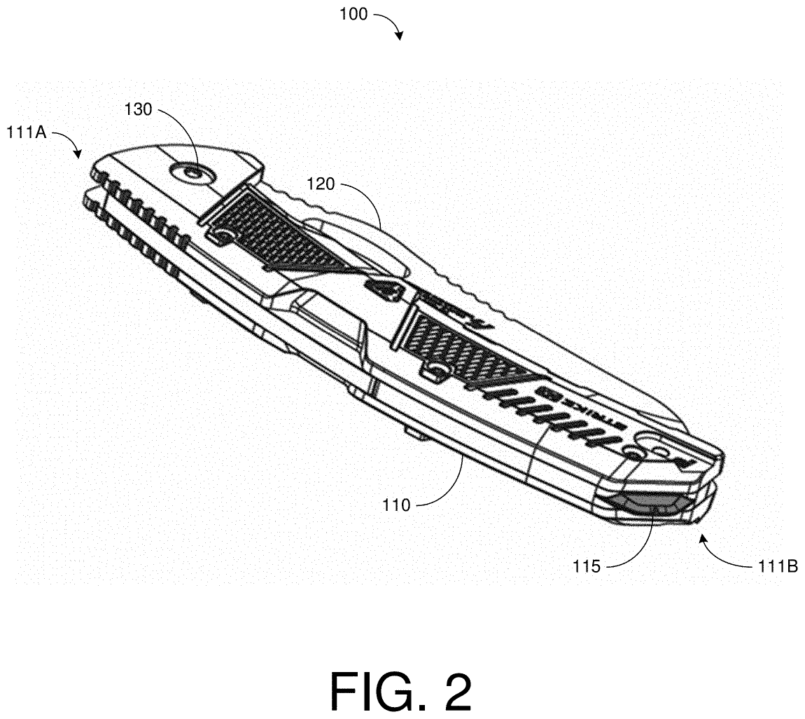

FIG. 3 is a diagram of a respective view of a device in accordance with an implementation of the present disclosure.

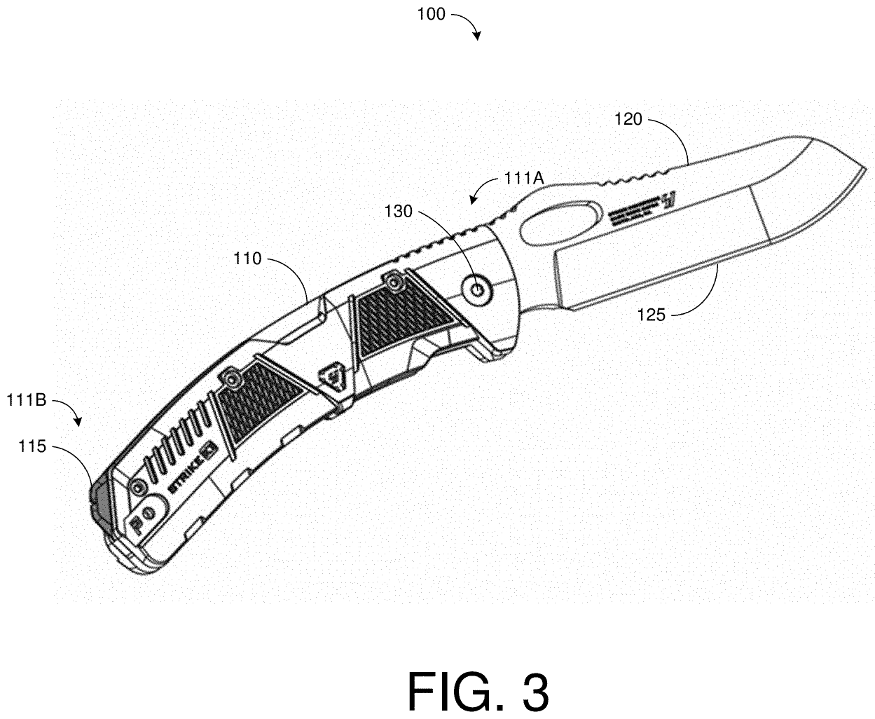

FIG. 4 is a diagram of an example scenario in accordance with an implementation of the present disclosure.

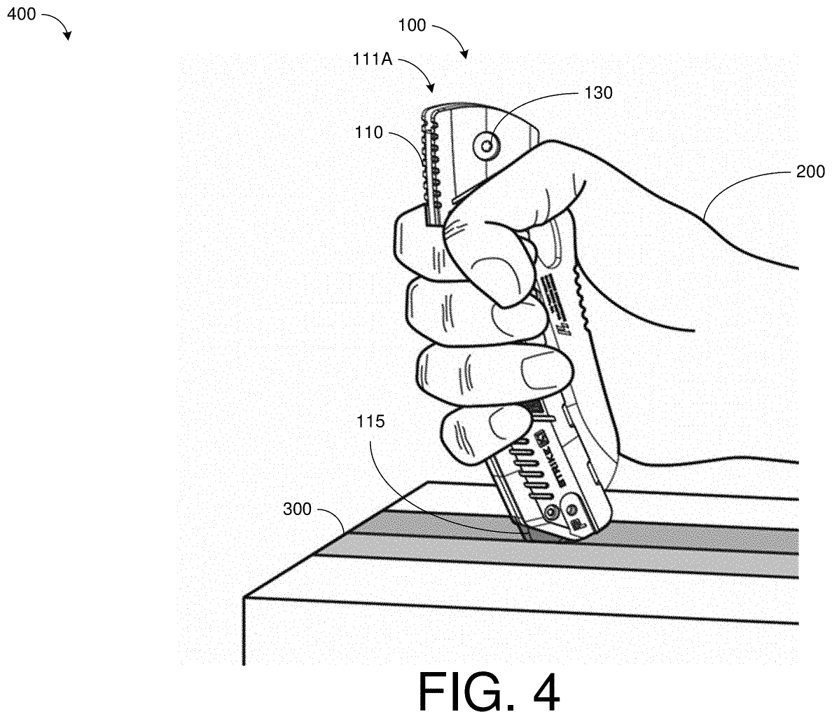

FIG. 5 is a diagram of a respective view of a device in accordance with an implementation of the present disclosure.

FIG. 6 is a diagram of a respective view of a device in accordance with an implementation of the present disclosure.

FIG. 7 is a diagram of a respective view of a device in accordance with an implementation of the present disclosure.

FIG. 8 is a diagram of a respective view of a device in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

The position terms used in the present disclosure, such as “front”, “forward”, “rear”, “back”, “top”, “bottom”, “left”, “right”, “head”, “tail” or the like assume a firearm in the normal firing position, with the firearm being in a position in which the longitudinal axis of the barrel of the firearm runs generally horizontally and the direction of firing points “forward” away from the operator or user of the firearm. The same convention applies for the direction statements used herein.

As used herein, the terms “proximal” and “proximally” may denote “forward” and “forwardly” with respect to the firearm, and the terms “distal” and “distally” may denote “rearward” and “rearwardly” with respect to the firearm. As used herein, the verb “to comprise” in this description, claims, and other conjugations are used in its non-limiting sense to mean those items following the word are included, but items not specifically mentioned are not excluded. As used herein, the word “forward” means moving in the direction that the projectile moves during firing a firearm. As used herein, the word “proximal” means closer to the reference point, in this case, the shooter. As used herein, the word “distal” means farther to the reference point, in this case, the shooter. Reference to an element by the indefinite article “a” or “an” does not exclude the possibility that more than one of the elements are present, unless the context clearly requires that there is one and only one of the elements. The indefinite article “a” or “an” thus usually means “at least one.” Additionally, the words “a” and “an” when used in the present document in concert with the words “comprising” or “containing” denote “one or more.

All numeric values are herein assumed to be modified by the term “about,” whether or not explicitly indicated. The term “about” generally refers to a range of numbers that one of skill in the art would consider equivalent to the recited value (i.e., having the same function or result). In many instances, the terms “about” may include numbers that are rounded to the nearest significant figure. The recitation of numerical ranges by endpoints includes all numbers within that range (e.g. 1 to 5 includes 1, 1.5, 2, 2.75, 3, 3.80, 4, and 5). All dimensions given herein are by way of examples to better illustrate the present disclosure embodiments and shall not be construed to limit the dimensions of the present disclosure embodiments to the given numeric values.

### Overview

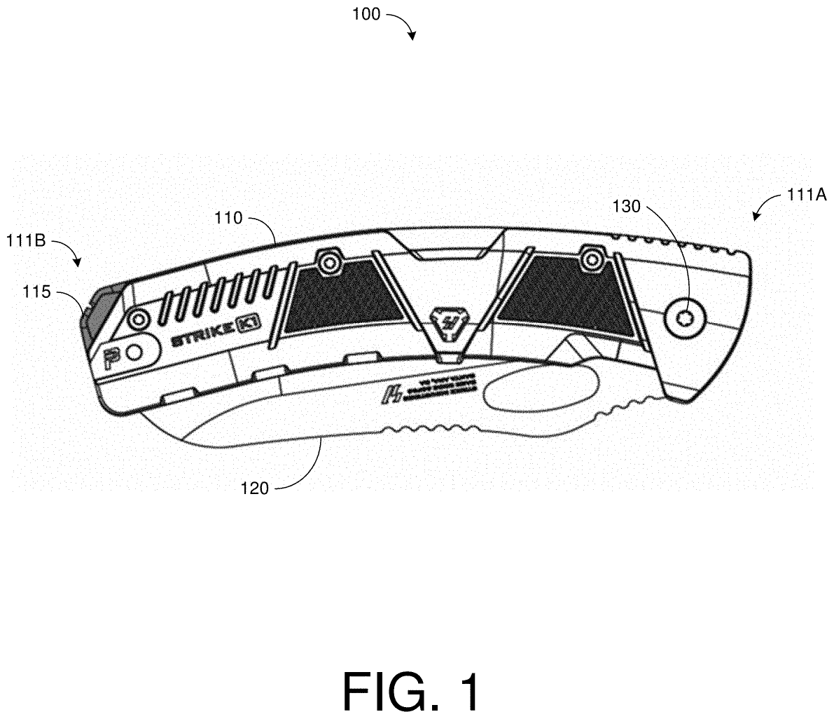

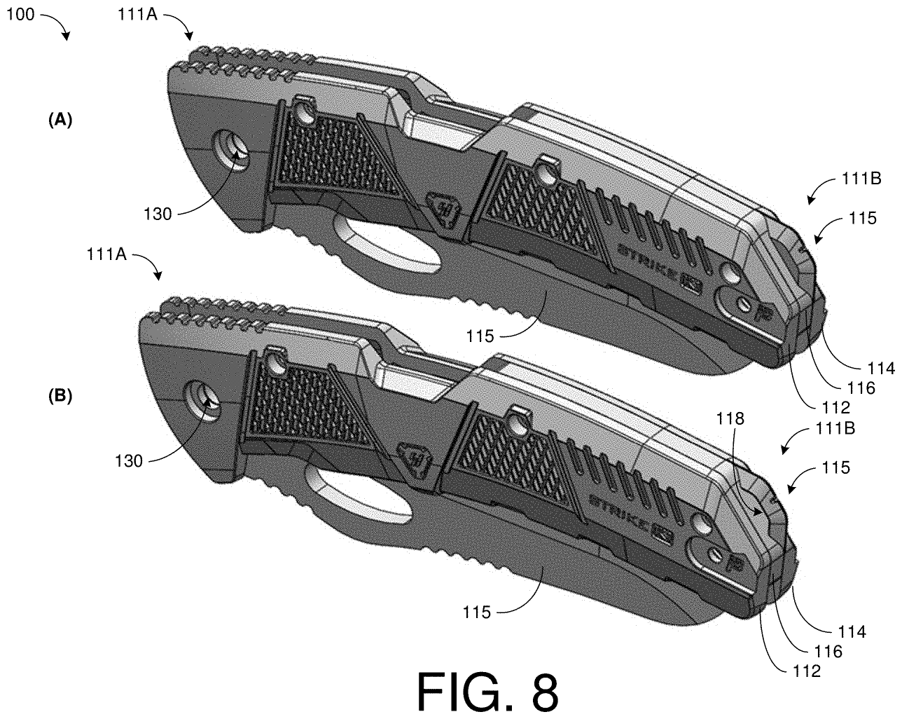

FIG. 1˜FIG. 8 each illustrates a respective view or scenario of a device 100 in accordance with various implementations of the present disclosure. Referring to FIG. 1˜FIG. 8, device 100 may include a handheld tool having a handle portion 110 and a knife portion 120. The handle portion 110 may have a first distal end 111A and a second distal end 111B opposite the first distal end 111A. The knife portion 120 may be coupled to the first distal end 111A of the handle portion 110, and the knife portion 120 may include a sharp blade 125. The second distal end 111B of the handle portion 110 may be configured with an edge as a dull blade 115. The dull blade 115 may be used as a tape cutter, thereby avoiding aforementioned issues associated with using a knife (which tends to be sharp) when opening boxes and packages. Dull blade 125 may be made of metal (e.g., carbon steel, tool steel, stainless steel, an alloy or another metal), polymer or a combination thereof. Compared to sharp blade 125, dull blade 115 is not sharp enough to cut or slice open fingers but can still cut open packaging tapes. For example, in the context of Brubacher Edge Sharpness Scale (BESS)™, sharpness of sharp blade 125 may be in a range of 0˜400 on the BESS™ scale while sharpness of dull blade 115 may be greater than 400 (>400) on the BESS™ scale.

Under a proposed design, the handle portion 110 may include a first panel 112, a second panel 114, and a central panel 116 sandwiched between the first panel 112 and the second panel 114. Moreover, the first panel 112 may generally face a first side (e.g., left side) of a user 200 and the second panel 114 may generally face a second side (e.g., right side) of the user 200 opposite the first side when the handheld tool is held by a hand of the user 200. Each of first panel 112, second panel 114 and central panel 116 may be made of metal (e.g., carbon steel, tool steel, stainless steel, an alloy or another metal), polymer or a combination thereof.

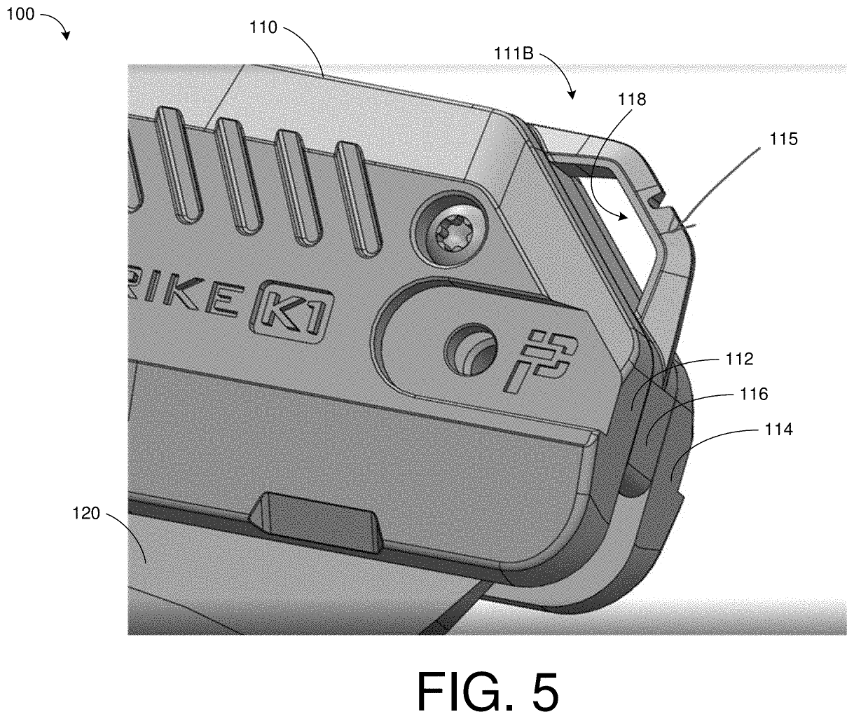

Under a proposed design, the dull blade 115 may be formed solely by a portion of the central panel 116, as shown in FIG. 5. Under this proposed design, dull blade 115 may be configured with a loop hole or opening 118 (e.g., for attaching a lanyard thereto), as shown in FIG. 5. Alternatively, under this proposed design, dull blade 115 may be a solid piece without any loop hole or opening.

Under a proposed design, the dull blade 115 may be formed solely by a portion of the first panel 112. Under this proposed design, dull blade 115 may be configured with a loop hole or opening 118 (e.g., for attaching a lanyard thereto). Alternatively, under this proposed design, dull blade 115 may be a solid piece without any loop hole or opening.

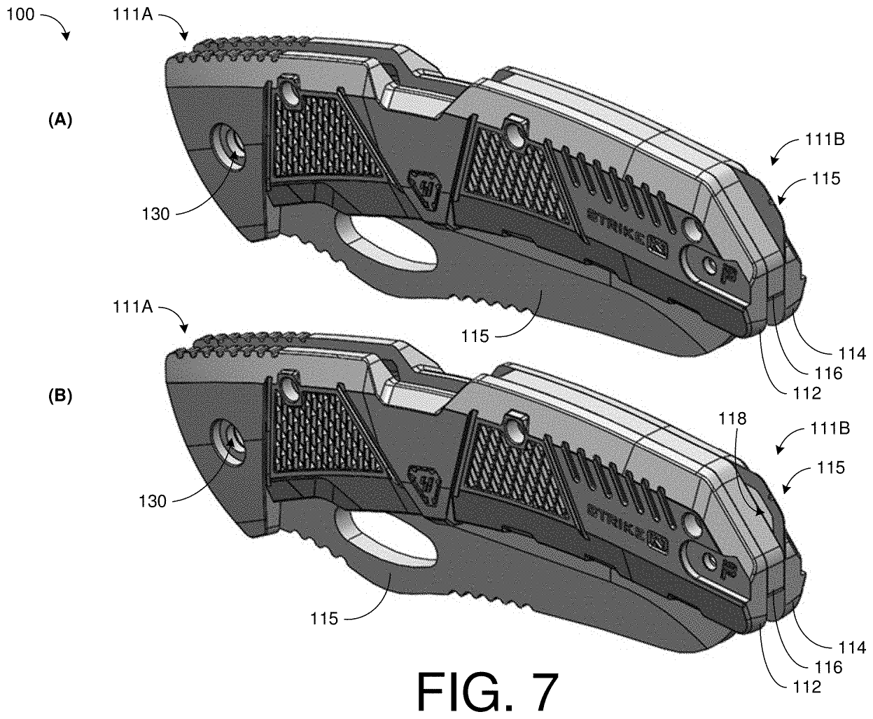

Under a proposed design, the dull blade 115 may be formed solely by a portion of the second panel 114, as shown in FIG. 7. Under this proposed design, dull blade 115 may be configured with a loop hole or opening 118 (e.g., for attaching a lanyard thereto), as shown in part (B) of FIG. 7. Alternatively, under this proposed design, dull blade 115 may be a solid piece without any loop hole or opening, as shown in part (A) of FIG. 7.

Under a proposed design, the dull blade 115 may be formed by a portion of the central panel 116 and a portion of the first panel 112. Under this proposed design, dull blade 115 may be configured with a loop hole or opening 118 (e.g., for attaching a lanyard thereto). Alternatively, under this proposed design, dull blade 115 may be a solid piece without any loop hole or opening.

Under a proposed design, the dull blade 115 may be formed by a portion of the central panel 116 and a portion of the second panel 114, as shown in FIG. 8. Under this proposed design, dull blade 115 may be configured with a loop hole or opening 118 (e.g., for attaching a lanyard thereto), as shown in part (B) of FIG. 8. Alternatively, under this proposed design, dull blade 115 may be a solid piece without any loop hole or opening, as shown in part (A) of FIG. 8.

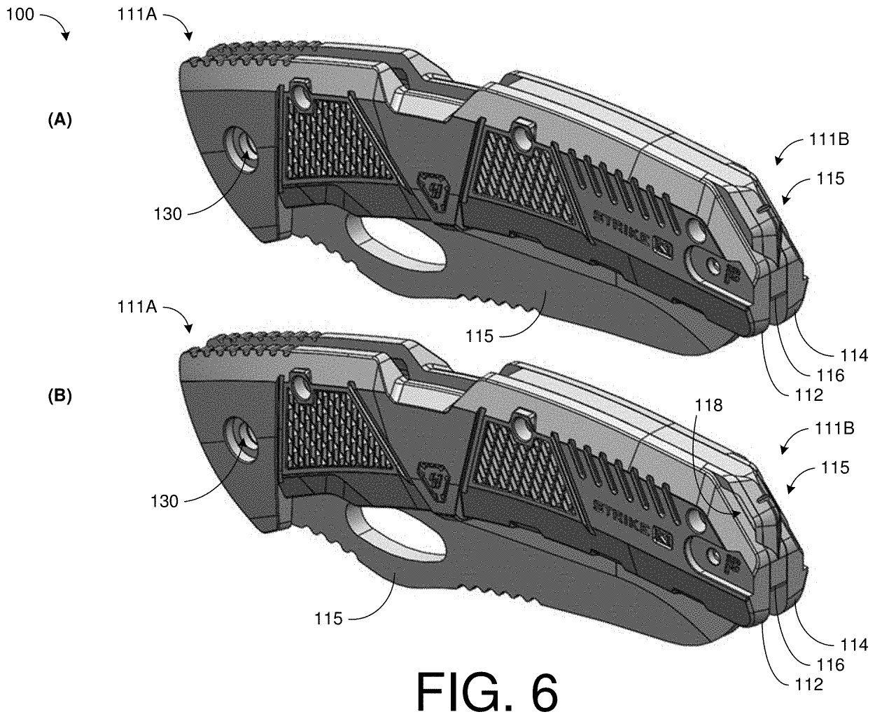

Under a proposed design, the dull blade 115 may be formed by a portion of the central panel 116, a portion of the first panel 112, and a portion of the second panel 114, as shown in FIG. 6. Under this proposed design, dull blade 115 may be configured with a loop hole or opening 118 (e.g., for attaching a lanyard thereto), as shown in part (B) of FIG. 6. Alternatively, under this proposed design, dull blade 115 may be a solid piece without any loop hole or opening, as shown in part (A) of FIG. 6.

Under a proposed design, the knife portion 120 may be pivotably coupled to the first distal end 111A of the handle portion 110 at a pivot 130. For instance, the knife portion 120 may be pivotable around pivot 130 to change between a first position (e.g., unfolded position) and a second position (e.g., folded/retrieved position) such that: (a) when in the first position, the knife portion 120 generally extends away from the second distal end 111B of the handle portion 110, and (b) when in the second position, the knife portion 120 is received in a recess of the handle portion 110 between the first panel 112 and the second panel 114.

### Example Implementations

In view of the above, the proposed design of a touch-free tool with multiple functions may be implemented in many ways. For illustrative purposes and without limiting the scope of the present disclosure, a few example implementations of the proposed design are described below.

In one aspect, a device (e.g., device 100) may include a handheld tool including a handle portion and a knife portion. The handle portion may have a first distal end and a second distal end opposite the first distal end. The knife portion may be coupled to the first distal end of the handle portion, and the knife portion may include a sharp blade. The second distal end of the handle portion may be configured with a dull blade.

In some implementations, the handle portion may include a first panel, a second panel, and a central panel sandwiched between the first panel and the second panel. Moreover, the first panel may generally face a first side of a user and the second panel may generally face a second side of the user opposite the first side when the handheld tool is held by a hand of the user.

In some implementations, the dull blade may be formed solely by a portion of the central panel.

In some implementations, the dull blade may be formed solely by a portion of the first panel.

In some implementations, the dull blade may be formed solely by a portion of the second panel.

In some implementations, the dull blade may be formed by a portion of the central panel and a portion of the first panel.

In some implementations, the dull blade may be formed by a portion of the central panel and a portion of the second panel.

In some implementations, the dull blade may be formed by a portion of the central panel, a portion of the first panel, and a portion of the second panel.

In some implementations, a material of the dull blade may include metal.

In some implementations, a material of the dull blade may include polymer.

In some implementations, the knife portion may be pivotably coupled to the first distal end of the handle portion. For instance, the knife portion may be pivotable between a first position and a second position such that: (a) when in the first position, the knife portion generally extends away from the second distal end of the handle portion, and (b) when in the second position, the knife portion is received in a recess of the handle portion.

In another aspect, a device (e.g., device 100) may include a handheld tool including a handle portion and a knife portion. The handle portion may have a first distal end and a second distal end opposite the first distal end. The handle portion may include a first panel, a second panel, and a central panel sandwiched between the first panel and the second panel. The knife portion may be pivotably coupled to the first distal end of the handle portion, and the knife portion may include a sharp blade. The second distal end of the handle portion may be configured with a dull blade. A material of the dull blade may include metal, polymer, or both.

In some implementations, the dull blade may be formed solely by a portion of the central panel.

In some implementations, the dull blade may be formed solely by a portion of the first panel.

In some implementations, the dull blade may be formed solely by a portion of the second panel.

In some implementations, the dull blade may be formed by a portion of the central panel and a portion of the first panel.

In some implementations, the dull blade may be formed by a portion of the central panel and a portion of the second panel.

In some implementations, the dull blade may be formed by a portion of the central panel, a portion of the first panel, and a portion of the second panel.

In some implementations, the knife portion may be pivotable between a first position and a second position such that: (a) when in the first position, the knife portion generally extends away from the second distal end of the handle portion, and (b) when in the second position, the knife portion is received in a recess of the handle portion.

### ADDITIONAL NOTES

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A device, comprising:
a handheld tool comprising:
a handle portion having a first distal end and a second distal end opposite the first distal end; and
a knife portion coupled to the first distal end of the handle portion, wherein:
the knife portion comprises a sharp blade, and
the second distal end of the handle portion is configured with a dull blade.

2. The device of claim 1, wherein the handle portion comprises a first panel, a second panel, and a central panel sandwiched between the first panel and the second panel, and wherein the first panel generally faces a first side of a user and the second panel generally faces a second side of the user opposite the first side when the handheld tool is held by a hand of the user.

3. The device of claim 2, wherein the dull blade is formed solely by a portion of the central panel.

4. The device of claim 2, wherein the dull blade is formed solely by a portion of the first panel.

5. The device of claim 2, wherein the dull blade is formed solely by a portion of the second panel.

6. The device of claim 2, wherein the dull blade is formed by a portion of the central panel and a portion of the first panel.

7. The device of claim 2, wherein the dull blade is formed by a portion of the central panel and a portion of the second panel.

8. The device of claim 2, wherein the dull blade is formed by a portion of the central panel, a portion of the first panel, and a portion of the second panel.

9. The device of claim 1, wherein a material of the dull blade comprises metal.

10. The device of claim 1, wherein a material of the dull blade comprises polymer.

11. The device of claim 1, wherein the knife portion is pivotably coupled to the first distal end of the handle portion.

12. The device of claim 11, wherein the knife portion is pivotable between a first position and a second position such that:
when in the first position, the knife portion generally extends away from the second distal end of the handle portion, and
when in the second position, the knife portion is received in a recess of the handle portion.

13. A device, comprising:
a handheld tool comprising:
a handle portion having a first distal end and a second distal end opposite the first distal end and comprising a first panel, a second panel, and a central panel sandwiched between the first panel and the second panel; and
a knife portion pivotably coupled to the first distal end of the handle portion,
wherein:
the knife portion comprises a sharp blade,
the second distal end of the handle portion is configured with a dull blade, and
a material of the dull blade comprises metal, polymer, or both.

14. The device of claim 13, wherein the dull blade is formed solely by a portion of the central panel.

15. The device of claim 13, wherein the dull blade is formed solely by a portion of the first panel.

16. The device of claim 13, wherein the dull blade is formed solely by a portion of the second panel.

17. The device of claim 13, wherein the dull blade is formed by a portion of the central panel and a portion of the first panel.

18. The device of claim 13, wherein the dull blade is formed by a portion of the central panel and a portion of the second panel.

19. The device of claim 13, wherein the dull blade is formed by a portion of the central panel, a portion of the first panel, and a portion of the second panel.

20. The device of claim 13, wherein the knife portion is pivotable between a first position and a second position such that:
when in the first position, the knife portion generally extends away from the second distal end of the handle portion, and
when in the second position, the knife portion is received in a recess of the handle portion.
